(19) United States
(12) Patent Application Publication
(10) Pub. No.: US 2011/0264885 A1
(43) Pub. Date: Oct. 27, 2011

(54) CONTROLLING CIRCUIT APPLICABLE IN PHYSICAL STORAGE DEVICE AND RELATED METHOD

(76) Inventors: Kai-Lung Cheng, Hsinchu City (TW); Hsu-Ting Chien, Taichung County (TW); Chun-Hung Kuo, Hsinchu City (TW)

(21) Appl. No.: 12/836,561

(22) Filed: Jul. 14, 2010

(30) Foreign Application Priority Data
Apr. 22, 2010 (TW) 099112675

(51) Int. Cl. G06F 12/06

(52) U.S. Cl. 711/173; 711/E12.084

(57) ABSTRACT

A controlling circuit applicable in a physical storage device includes: a dividing circuit coupled to the physical storage device for dividing a storage capacity of the physical storage device into a plurality of divided storage areas, wherein a divided storage capacity of each divided storage area is not larger than the capacity corresponding to the largest address generated by an operating system; and a feedback circuit coupled to the dividing circuit for feeding back the plurality of divided storage areas to the operating system such that the operating system regards the plurality of divided storage areas as a plurality of independent physical storage devices.

### BACKGROUND OF THE INVENTION

1. Field of the Invention

The present invention relates to a controlling circuit applicable in a physical storage device and a related method, and more particularly to a controlling circuit for dividing a physical storage device into a plurality of divided storage areas and a method thereof.

2. Description of the Prior Art

When a computer is under operation, an operating system installed in the computer may access a storage device, such as a hard disk. Normally, the operating system is designed to have the ability of addressing a range of a certain capacity. In other words, the operating system corresponds to a maximum capacity that can be addressed. For example, the operating system of Windows XP produced by Microsoft© has a maximum capacity of 2 Tera-bytes (TB) that Windows XP is able to address. Therefore, when a storage device has a capacity larger than 2 TB, Windows XP is not able to address the area of the storage device. Accordingly, the area of the storage device larger than 2 TB is wasted. When an operating system is operated to access a storage device, in which the storage device has a capacity larger than the maximum addressing capacity of the operating system, providing an efficient and convenient way to address the area of the storage device larger than the maximum addressing capacity becomes a significant concern.

### SUMMARY OF THE INVENTION

One of the objectives of the present invention is therefore to provide a controlling circuit for dividing a physical storage device into a plurality of divided storage areas, and a related method, to solve the above-mentioned problems.

According to a first embodiment of the present invention, a controlling circuit applicable in a physical storage device is disclosed. The controlling circuit comprises a dividing circuit and a feedback circuit. The dividing circuit is coupled to the physical storage device for dividing a storage capacity of the physical storage device into a plurality of divided storage areas, wherein a divided storage capacity of each divided storage area is not larger than a maximum capacity which is capable of being addressed by an operating system. The feedback circuit is coupled to the dividing circuit for feeding back information of the plurality of divided storage areas to the operating system such that the operating system regards the plurality of divided storage areas as a plurality of independent physical storage devices.

According to a second embodiment of the present invention, a controlling method applicable in a physical storage device is disclosed. The controlling method comprises: dividing a storage capacity of the physical storage device into a plurality of divided storage areas, wherein a divided storage capacity of each divided storage area is not larger than a maximum capacity which is capable of being addressed by an operating system; and feeding back information of the plurality of divided storage areas to the operating system such that the operating system regards the plurality of divided storage areas as a plurality of independent physical storage devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a computing system according to an exemplary embodiment of the present invention.

FIG. 2 is a diagram illustrating a dividing circuit and a physical storage device after division according to an exemplary embodiment of the present invention.

FIG. 3 is a flowchart illustrating a controlling method applicable in the physical storage device according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

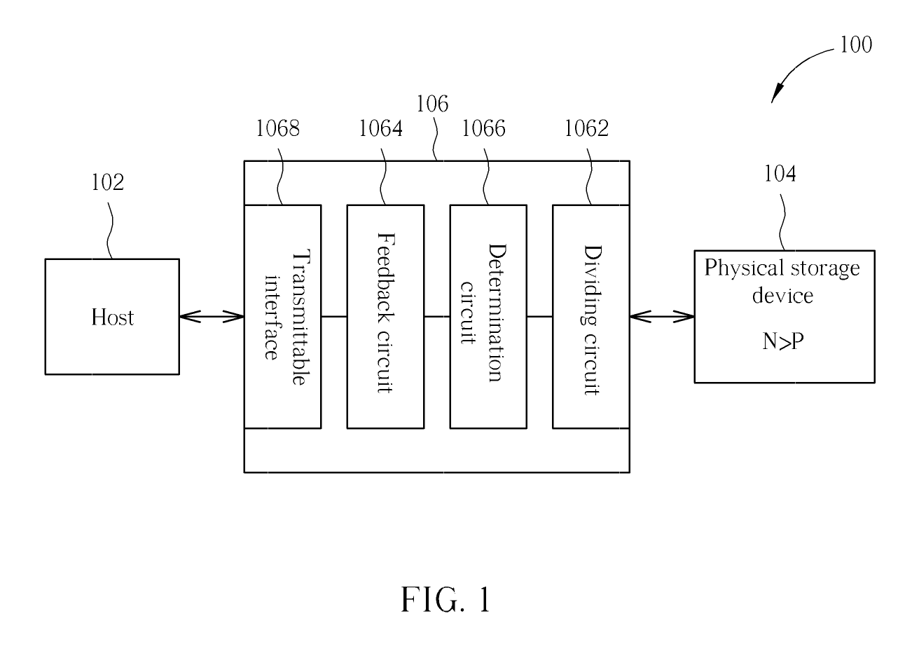

Please refer to FIG. 1. FIG. 1 is a diagram illustrating a computing system 100 according to an embodiment of the present invention. The computing system 100 comprises a host 102, a physical storage device 104, and a controlling circuit 106 applicable in the physical storage device 104. An operating system (OS), such as Windows XP, is installed in the host 102. The physical storage device 104 is coupled to the controlling circuit 106, and the controlling circuit 106 is coupled to the host 102. The controlling circuit 106 comprises a dividing circuit 1062, a feedback circuit 1064, a determination circuit 1066, and a transmittable interface 1068. The dividing circuit 1062 is coupled to the physical storage device 104 for dividing a storage capacity N of the physical storage device 104 into a plurality of divided storage areas, wherein a divided storage capacity of each divided storage area is not larger than a maximum capacity P which is capable of being addressed by the operating system. The feedback circuit 1064 is coupled to the dividing circuit 1062 for feeding back information of the plurality of divided storage areas to the operating system such that the operating system regards the plurality of divided storage areas as a plurality of independent physical storage devices. The determination circuit 1066 is coupled to the dividing circuit 1062 for determining if the storage capacity N of the physical storage device 104 is larger than the maximum capacity P which is capable of being addressed by the operating system. In this embodiment, the dividing circuit 1062 divides the storage capacity N of the physical storage device 104 into the plurality of divided storage areas after the determination circuit 1066 determines that the storage capacity N of the physical storage device 104 is larger than the maximum capacity P.

For the above example of operating system Windows XP, the maximum capacity is 2 Tera-bytes (TB); therefore, the controlling circuit divides the physical storage device 104 into a plurality of divided storage areas when the storage capacity N of the physical storage device 104 is larger than 2 TB, wherein a divided storage capacity of each divided storage area is 2 TB or smaller than 2 TB. More specifically, when the storage capacity N of the physical storage device 104 is larger than 2 TB, the controlling circuit 106 divides the physical storage device 104 by 2 TB (or less than 2 TB) such that each divided storage area has the capacity of 2 TB (or less than 2 TB). Then, the feedback circuit 1064 feeds the information of the divided storage areas back to the operating system Windows XP of the host 102. Accordingly, the operating system Windows XP regards the plurality of divided storage areas as a plurality of independent physical storage devices. Therefore, the host is able to address the plurality of independent physical storage devices individually for accessing the physical storage device 104 since each of the divided storage areas of the physical storage device 104 is 2 TB or smaller than 2 TB. Although the controlling circuit 106 comprises the dividing circuit 1062, the feedback circuit 1064, the determination circuit 1066, and the transmittable interface 1068 in this embodiment, the dividing circuit 1062, the feedback circuit 1064, and the determination circuit 1066 can also be integrated into a processing circuit having the related functions, which also belongs to the scope of the present invention.

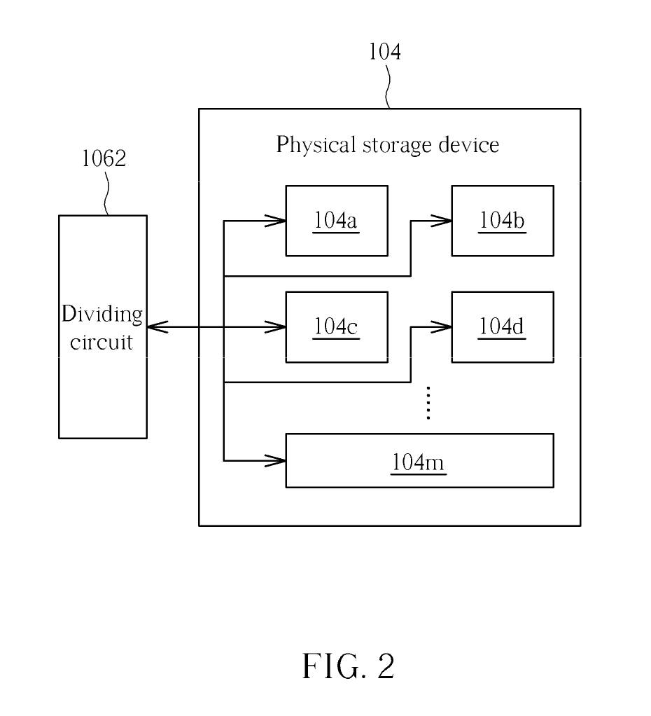

Please refer to FIG. 2. FIG. 2 is a diagram illustrating the dividing circuit 1062 and the physical storage device 104 after division (i.e. the plurality of divided storage areas 104a-104m) according to an embodiment of the present invention. The dividing circuit 1062 comprises an arithmetic unit 1062a and a dividing unit 1062b. The arithmetic unit 1062a calculates a dividing number M according to the maximum capacity P which is capable of being addressed by the operating system and the storage capacity N of the physical storage device 104. The dividing unit 1062b is coupled to the arithmetic unit 1062a and the physical storage device 104 for dividing the storage capacity N of the physical storage device 104 into the plurality of divided storage areas 104a-104m according to the dividing number M. When the remaining storage capacity N of the physical storage device 104 divided by the maximum capacity P which is capable of being addressed by the operating system is larger than zero, the arithmetic unit 1062a calculates the dividing number M according to the first equation (a) as below:

M=[(N/P)+1]. (a)

In other words, the dividing unit 1062b first divides the physical storage device 104 into N/P independent storage devices equally, and then defines the last storage device having capacity smaller than the maximum capacity P as another independent storage device.

When the remaining storage capacity N of the physical storage device 104 divided by the maximum capacity P which is capable of being addressed by the operating system is equal to zero, the arithmetic unit 1062a calculates the dividing number M according to the first equation (b) as below:

M=[(N/P)]. (b)

Therefore, the dividing unit 1062b merely divides the physical storage device 104 into N/P independent storage devices equally. Please note that the present invention is not limited to utilizing the dividing unit 1062b to physically divide the physical storage device 104. Any other methods having similar effects also belong to the scope of the present invention. For example, the controlling circuit 106 may run software to divide the physical storage device 104 into a plurality of virtual storage devices 104a-104m such that the operating system regards the plurality of virtual storage areas 104a-104m as a plurality of independent physical storage devices. This also belongs to the scope of the present invention.

In this embodiment, the physical storage device 104 and the controlling circuit 106 are installed in an external storage device, which is coupled to the host 102 externally, but this is not meant to be the limitation of the present invention. Therefore, the physical storage device 104 and the controlling circuit 106 can also be installed in an internal storage device. In addition, the present invention does not limit the physical storage device 104 to a specific type of storage device. The physical storage device 104 can be a hard disk, a flash memory disk, a solid state disk, or a magnetic storage disk. Furthermore, the present invention does not limit the transmittable interface 1068 to conform to a specific data transmitting specification. The transmittable interface 1068 may conform to a universal serial bus (USB) 2.0 specification, a universal serial bus 3.0 specification, a serial advanced technology attachment (SATA) specification, or an external serial advanced technology attachment (eSATA) specification. Therefore, the transmittable interface 1068 may be a universal serial bus (USB) 2.0 interface, a universal serial bus 3.0 interface, a serial advanced technology attachment (SATA) interface, or an external serial advanced technology attachment (eSATA) interface.

More specifically, for the example of Windows XP, when a USB 2.0 external hard disk having the capacity of larger than 2 TB is coupled to the host 102, the present controlling circuit 106 divides the hard disk by 2 TB or less than 2 TB to generate a plurality of divided storage areas having the same or different capacity, and then the controlling circuit 106 feeds a total number of divided storage areas back to the OS (Windows XP) such that the OS regards the hard disk as having the total number of USB 2.0 external hard disk. When a USB 3.0 external hard disk having the capacity of larger than 2 TB is coupled to the host 102, the present controlling circuit 106 divides the hard disk by 2 TB or less than 2 TB to generate a plurality of divided storage areas having the same or different capacity, and then the controlling circuit 106 feeds a total number of divided storage areas back to the OS such that the OS regards the hard disk as having the total number of USB 3.0 external hard disk. When an eSATA external hard disk having the capacity of larger than 2 TB is coupled to the host 102, the present controlling circuit 106 divides the hard disk by 2 TB or less than 2 TB to generate a plurality of divided storage areas having the same or different capacity, and then the controlling circuit 106 feeds a total number of divided storage areas back to the OS such that the OS regards the hard disk as having the total number of eSATA external hard disk. When a USB 2.0 flash memory disk having the capacity of larger than 2 TB is coupled to the host 102, the present controlling circuit 106 divides the flash memory disk by 2 TB or less than 2 TB to generate a plurality of divided storage areas having the same or different capacity, and then the controlling circuit 106 feeds a total number of divided storage areas back to the OS such that the OS regards the flash memory disk as having the total number of USB 2.0 flash memory disk. When a USB 3.0 flash memory disk having the capacity of larger than 2 TB is coupled to the host 102, the present controlling circuit 106 divides the flash memory disk by 2 TB or less than 2 TB to generate a plurality of divided storage areas having the same or different capacity, and then the controlling circuit 106 feeds a total number of divided storage areas back to the OS such that the OS regards the flash memory disk as having the total number of USB 3.0 flash memory disk. When an eSATA flash memory disk having the capacity of larger than 2 TB is coupled to the host 102, the present controlling circuit 106 divides the flash memory disk by 2 TB or less than 2 TB to generate a plurality of divided storage areas having the same or different capacity, and then the controlling circuit 106 feeds a total number of divided storage areas back to the OS such that the OS regards the flash memory disk as having the total number of eSATA flash memory disk. When a SATA solid state disk having the capacity of larger than 2 TB is coupled to the host 102, the present controlling circuit 106 divides the solid state disk by 2 TB or less than 2 TB to generate a plurality of divided storage areas having the same or different capacity, and then the controlling circuit 106 feeds a total number of divided storage areas back to the OS such that the OS regards the solid state disk as having the total number of SATA solid state disk. When a USB 2.0 magnetic storage disk having the capacity of larger than 2 TB is coupled to the host 102, the present controlling circuit 106 divides the magnetic storage disk by 2 TB or less than 2 TB to generate a plurality of divided storage areas having the same or different capacity, and then the controlling circuit 106 feeds a total number of divided storage areas back to the OS such that the OS regards the magnetic storage disk as having the total number of USB 2.0 magnetic storage disk. When a USB 3.0 magnetic storage disk having the capacity of larger than 2 TB is coupled to the host 102, the present controlling circuit 106 divides the magnetic storage disk by 2 TB or less than 2 TB to generate a plurality of divided storage areas having the same or different capacity, and then the controlling circuit 106 feeds a total number of divided storage areas back to the OS such that the OS regards the magnetic storage disk as having the total number of USB 3.0 magnetic storage disk. When an eSATA magnetic storage disk having the capacity of larger than 2 TB is coupled to the host 102, the present controlling circuit 106 divides the magnetic storage disk by 2 TB or less than 2 TB to generate a plurality of divided storage areas having the same or different capacity, and then the controlling circuit 106 feeds a total number of divided storage areas back to the OS such that the OS regards the magnetic storage disk as having the total number of eSATA magnetic storage disk.

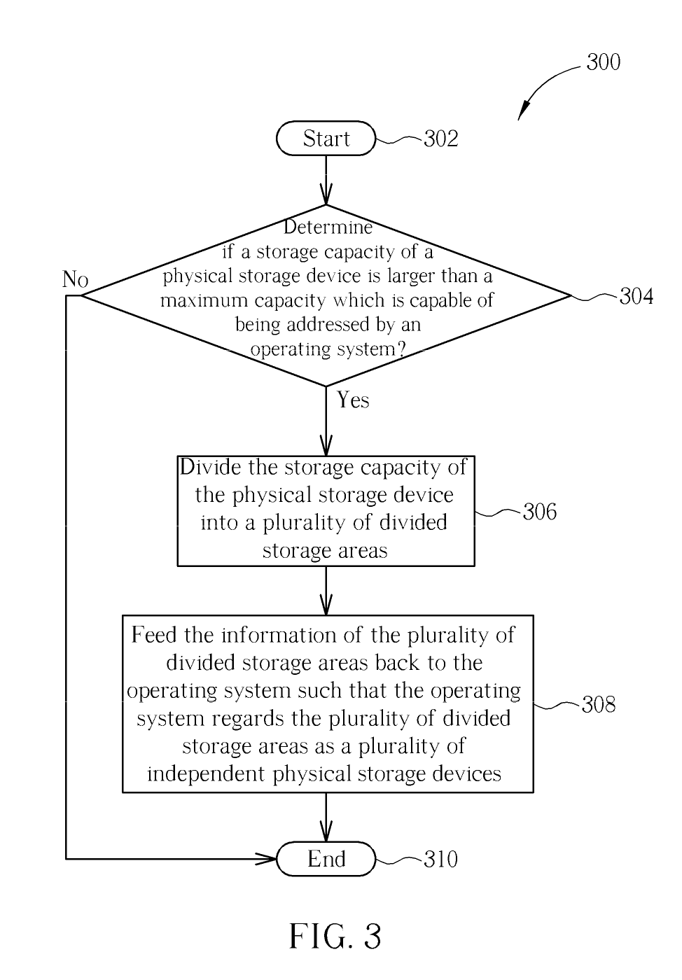

Please refer to FIG. 3. FIG. 3 is a flowchart illustrating a controlling method 300 applicable in a physical storage device according to an embodiment of the present invention. Please note that the controlling method 300 is described in relation to the above-mentioned physical storage device 104 to more clearly illustrate the features of the present invention. Provided that substantially the same result is achieved, the steps of the flowchart shown in FIG. 3 need not be in the exact order shown and need not be contiguous; that is, other steps can be intermediate. The controlling method 300 comprises the steps of:

Step 302: Start;

Step 304: Determine if the storage capacity N of the physical storage device 104 is larger than the maximum capacity P which is capable of being addressed by the operating system, if yes, go to step 306, if no, go to step 310;

Step 306: Divide the storage capacity N of the physical storage device 104 into the plurality of divided storage areas 104a-104m;

Step 308: Feed the information of the plurality of divided storage areas 104a-104m back to the operating system such that the operating system regards the plurality of divided storage areas 104a-104m as a plurality of independent physical storage devices;

Step 310: End.

As the operating system is not able to address the area of the storage device larger than the maximum capacity P, the physical storage device 104 having the storage capacity N is divided into the plurality of divided storage areas 104a-104m in the step 306 when the storage capacity N of the physical storage device 104 is larger than the maximum capacity P, wherein each divided storage area is not larger than the maximum capacity P which is capable of being addressed by the operating system. Then, the feedback circuit 1064 feeds the information of the plurality of divided storage areas 104a-104m back to the operating system such that the operating system regards the plurality of divided storage areas 104a-104m as the plurality of independent physical storage devices. Therefore, the host 102 is able to address the plurality of independent physical storage devices individually for accessing the physical storage device 104 since each of the divided storage areas of the physical storage device 104 is not larger than the maximum capacity P.

To summarize, in the present embodiment, the controlling circuit 106 is arranged to divide the physical storage device 104 having storage capacity N according to the maximum capacity P which is capable of being addressed by the operating system, such that the operating system regards the plurality of divided storage areas 104a-104m as the plurality of independent physical storage devices to solve the problems faced by conventional methods.

Those skilled in the art will readily observe that numerous modifications and alterations of the device and method may be made while retaining the teachings of the invention.

What is claimed is:

1. A controlling circuit applicable in a physical storage device, comprising:
a dividing circuit, coupled to the physical storage device, for dividing a storage capacity of the physical storage device into a plurality of divided storage areas, wherein a divided storage capacity of each divided storage area is not larger than a maximum capacity which is capable of being addressed by an operating system; and
a feedback circuit, coupled to the dividing circuit, for feeding back information of the plurality of divided storage areas to the operating system such that the operating system regards the plurality of divided storage areas as a plurality of independent physical storage devices.

2. The controlling circuit of claim 1, further comprising:
a determination circuit, coupled to the dividing circuit, for determining if the storage capacity of the physical storage device is larger than the maximum capacity which is capable of being addressed by the operating system;
wherein the dividing circuit divides the storage capacity of the physical storage device into the plurality of divided storage areas after the determination circuit determines that the storage capacity of the physical storage device is larger than the maximum capacity which is capable of being addressed by the operating system.

3. The controlling circuit of claim 1, wherein the physical storage device and the controlling circuit are installed in an external storage device.

4. The controlling circuit of claim 3, wherein the physical storage device is a hard disk, a flash memory disk, a solid state disk, or a magnetic storage disk.

5. The controlling circuit of claim 1, wherein the physical storage device is a hard disk, a flash memory disk, a solid state disk, or a magnetic storage disk.

6. The controlling circuit of claim 1, further comprising:
a transmittable interface, coupled to the feedback circuit, for performing a signal transmission with a host according to a specific data transmitting specification;
wherein the specific data transmitting specification conforms to a universal serial bus (USB) 2.0 specification, a universal serial bus 3.0 specification, a serial advanced technology attachment (SATA) specification, or an external serial advanced technology attachment (eSATA) specification.

7. The controlling circuit of claim 1, wherein the dividing circuit comprises:
an arithmetic unit, for calculating a dividing number according to the maximum capacity which is capable of being addressed by the operating system and the storage capacity of the physical storage device; and
a dividing unit, coupled to the arithmetic unit and the physical storage device, for dividing the storage capacity of the physical storage device into the plurality of divided storage areas according to the dividing number.

8. The controlling circuit of claim 7, wherein when a remaining storage capacity of the physical storage device divided by the maximum capacity which is capable of being addressed by the operating system is larger than zero, the arithmetic unit calculates the dividing number according to an equation:
M=[(N/P)+1], wherein M represents the dividing number, N represents the storage capacity of the physical storage device, and P represents the maximum capacity which is capable of being addressed by the operating system.

9. The controlling circuit of claim 7, wherein when a remaining storage capacity of the physical storage device divided by the maximum capacity which is capable of being addressed by the operating system is equal to zero, the arithmetic unit calculates the dividing number according to an equation:
M=(N/P), wherein M represents the dividing number, N represents the storage capacity of the physical storage device, and P represents the maximum capacity which is capable of being addressed by the operating system.

10. A controlling method applicable in a physical storage device, comprising:
dividing a storage capacity of the physical storage device into a plurality of divided storage areas, wherein a divided storage capacity of each divided storage area is not larger than a maximum capacity which is capable of being addressed by an operating system; and
feeding back information of the plurality of divided storage areas to the operating system such that the operating system regards the plurality of divided storage areas as a plurality of independent physical storage devices.

11. The controlling method of claim 10, further comprising:
determining if the storage capacity of the physical storage device is larger than the maximum capacity which is capable of being addressed by the operating system; and
dividing the storage capacity of the physical storage device into the plurality of divided storage areas after determining that the storage capacity of the physical storage device is larger than the maximum capacity which is capable of being addressed by the operating system.

12. The controlling method of claim 10, wherein the physical storage device and the controlling method are applicable in an external storage device.

13. The controlling method of claim 10, further comprising:
performing a signal transmission with a host according to a specific data transmitting specification;
wherein the specific data transmitting specification conforms to a universal serial bus (USB) 2.0 specification, a universal serial bus 3.0 specification, a serial advanced technology attachment (SATA) specification, or an external serial advanced technology attachment (eSATA) specification.

14. The controlling method of claim 10, wherein the step of dividing the storage capacity of the physical storage device into the plurality of divided storage areas comprises:
calculating a dividing number according to the maximum capacity which is capable of being addressed by the operating system and the storage capacity of the physical storage device; and
dividing the storage capacity of the physical storage device into the plurality of divided storage areas according to the dividing number.

15. The controlling method of claim 14, wherein when a remaining storage capacity of the physical storage device divided by the maximum capacity which is capable of being addressed by the operating system is larger than zero, the step of calculating the dividing number according to the maximum capacity which is capable of being addressed by the operating system and the storage capacity of the physical storage device comprises:
calculating the dividing number according to an equation:
M=[(N/P)+1], wherein M represents the dividing number, N represents the storage capacity of the physical storage device, and P represents the maximum capacity which is capable of being addressed by the operating system.

16. The controlling method of claim 14, wherein when a remaining storage capacity of the physical storage device divided by the maximum capacity which is capable of being addressed by the operating system is equal to zero, the step of calculating the dividing number according to the maximum capacity which is capable of being addressed by the operating system and the storage capacity of the physical storage device comprises:
calculating the dividing number according to an equation:
M=(N/P), wherein M represents the dividing number, N represents the storage capacity of the physical storage device, and P represents the maximum capacity which is capable of being addressed by the operating system.
